(19) United States
(12) Patent Application Publication
(10) Pub. No.: US 2006/0093309 A1
(43) Pub. Date: May 4, 2006

(54) System and method for creating a photo movie

(75) Inventors: Tilman Herberger, Dresden (DE); Titus Tost, Dresden (DE)

Correspondence Address: FELLERS SNIDER BLANKENSHIP;BAILEY & TIPPENS, THE KENNEDY BUILDING, 321 SOUTH BOSTON SUITE 800, TULSA, OK, 74103-3318, US

(73) Assignee: MAGIX AG

(21) Appl. No.: 10/958,706

(22) Filed: Oct. 5, 2004

(51) Int. Cl. H04N 5/781

(52) U.S. Cl. 386/46; 386/125

(57) ABSTRACT

There is provided herein a system and method for the efficient creation of a digital video work from a number of digital still images. The instant method will provide the essential functions required for the creation of such a video work via an intuitive and easy to use graphical user interface. Additionally, the instant invention will enable the user to select and apply transformations and effects with only minimal user interaction, preferably via a single mouse click.

### FIELD OF THE INVENTION

The present invention relates generally to the field of creating and editing digital multimedia works. More particularly, but not by way of limitation, the present invention relates to processes which provide- the user of a digital media creation program with a customized graphical user interface that has been specifically designed to efficiently enable a user to create video works out of a plurality of digital still images.

### BACKGROUND OF THE INVENTION

In the past few years there has been a continuing trend toward the use of a personal computer as a platform for entertainment and recreation, with personal computers being increasingly used in multimedia contexts. One factor that has hastened this movement is the ongoing digitalisation of the entertainment area. For example digital video cameras can now be connected to a personal computer and recordings can easily be transferred thereto for further editing, thereby giving the user the opportunity to interact and work with his or her own recordings in a way that would have been impossible even a few short years ago. Digital video still cameras have seen a similar increase in features and connectivity. These sorts of devices have undergone a massive technological boost in the last couple of years, with the technical equipment and features of these devices becoming more sophisticated with each technological step forward.

Of course, given the digital nature of these devices connectivity to a personal computer was a foregone conclusion and such interconnectivity has enabled a user to transfer multimedia data to a personal computer for safekeeping and editing. However, the development of software for use by the (often novice) end user has tended to lag behind the technology curve.

By way of explanation, software for editing digital video materials has long been available in the consumer market. With this sort of software an ambitious user can create (semi) professional polished video works in his or her own home. Of course, home multimedia editing programs have improved along with the hardware technology and have experienced an explosion of new capabilities and features.

With the increasing penetration of digital photo devices into the consumer market and the growing demand for software that allows users to create complex and sophisticated movie effects, software companies have continually expanded their feature sets at each software revision. However, for financial or other reasons, a new feature is often grafted onto an existing software product as an additional menu item or an obscure button within an already overly complex program design, thereby making the task at hand even harder for the user who may very well be a novice or casual user. Of course, in many cases the better choice (at least from the consumer's standpoint) would be to release a separate stand-alone program that was focused on the requisite functionality and which would be easier to use. There are obvious financial disincentives for doing this, however.

Of course, when feature proliferation is rampant the end user is often at a loss as to how to perform even simple operations, thereby making it likely that he or she will become frustrated with that particular program and, more generally, with multimedia editing.

This problem is compounded by the fact that—whether due to poor initial organization or later feature expansion—the functionality of most multimedia editing programs is spread over—several different sections of the graphical user interface so that the user may have to navigate through a variety of different menus, buttons and tabs to accomplish conceptually simple tasks. Finding that one computer menu or screen display that contains the sought-after parameter can be a frustrating task for the user which may be made all the more difficult by a mismatch between the user's screen resolution and the expected resolution.

These problems are especially apparent where a user seeks to create a video work from a collection of still photos. By way of explanation, there are millions of video still cameras in the hands of the public. The owners of such cameras predictably want to share those images with relatives and friends. A natural way to do that is to assemble the digital slides into a video work that can be played, for example, on any conventional DVD player. Further, most users would like some control over the video transitions that are utilized between successive digital images, would enjoy creating an audio track (e.g., a music sound track) to accompany the playing of the slide show, etc. However, general purpose movie creation and editing software does not allow a user to easily accomplish this simple task and such software, although powerful, typically has a bewildering arrays of menu items that tends to make completion of this task unnecessarily difficult.

Thus, what is needed is a system and method that enables a user to create a digital video work out of a plurality of available digital still images with the help of a graphical user interface, wherein the graphical user interface is designed to contain the essential functions needed to create a digital video work in at least one graphical display screen. This invention features a specifically designed graphical user interface, wherein the essential functions are selectable by the user of the instant invention with only one user interaction, preferably a mouse click.

Heretofore, as is well known in the media editing industry, there has been a need for an invention to address and solve the above-described problems. Accordingly it should now be recognized, as was recognized by the present inventors, that there exists, and has existed for some time, a very real need for a system and method that would address and solve the above-described problems.

Before proceeding to a description of the present invention, however, it should be noted and remembered that the description of the invention which follows, together with the accompanying drawings, should not be construed as limiting the invention to the examples (or preferred embodiments) shown and described. This is so because those skilled in the art to which the invention pertains will be able to devise other forms of the invention within the ambit of the appended claims.

### SUMMARY OF THE INVENTION

There is provided herein a system and method for assisting a user in the creation of a digital video work from of a collection of digital still images, wherein the user's interaction with the computer will preferably be controlled by a single action, e.g., a single mouse click. The graphical user interface that is preferably used will place the essential functions that are necessary to create a video work from a collection of digital still images within easy reach of the user. The instant invention makes it possible for a user to assemble a collection of digital still images into a video work more quickly and efficiently than has otherwise been possible. Additionally, as much of the assembly process as is possible will be automated, thereby further assisting the user in the completion of the desired multimedia work.

According to a preferred embodiment the instant invention will be implemented in the form of a computer program. Preferably, the program will be directed entirely to the editing and processing of digital still images into a video work and will offer various options suitable to that task. Additionally, a specially designed graphical user interface will preferably be provided which contains the essential functions necessary for an easy digital video work creation process in one display screen. Finally, it is preferred that the program functions are most essential to the process of creating the vide work be initiated as efficiently as possible, preferably with a single mouse click.

Note that for purposes of the instant disclosure the term “graphical user interface” should be interpreted as broadly as possible to refer to an on-screen user interface which enables the user to efficiently interact with the features of the underlying software program.

As a first preferred step in the instant invention the user will load images from a digital still camera onto his or her hard disk or otherwise make them readable by a program running on the user's computer. Next, a program that implements the instant invention will be initiated and the collection of digital still images will preferably be read either from the user's own hard disk (where they have been previously stored) or directly from an attached camera. The digital images will preferably be placed into an image database for subsequent recall when the video work is rendered. Of course, it is also possible that the user will want to add additional images from other sources (e.g., clip art to use in transitions) and the instant invention readily accommodates that option.

As a next preferred step, after the user selected the digital still images which he wants to use in the digital video work, the instant invention will preferably display a customized graphical user interface. This interface preferably utilizes a large section of the screen in which the currently selected still image is displayed. Additionally, there will preferably be provided various buttons and other on-screen control indicia such as video transport controls (e.g., play, rewind, fast forward, etc.) to allow the user to interact with and control the various aspects of the executing program. Preferably, there will be control items that allow the user to page forward and backward through thumbnail graphics that represent the assembled collection of digital images and that control the playing of the video work during editing. Additionally, controls will preferably be provided to allow a user to apply video effects to any of the digital images (e.g., zoom, pan, rotate, filter, etc.) and apply transitions therebetween.

As a next preferred step, the instant invention will display the imported or selected still images in the preview section of the graphical user interface. The images may be ordered automatically by the instant program by, for example, creation date or the user might choose to order them according to his or her own personal liking. In either case, the user will next preferably be given an opportunity to define movement effects (e.g., pan, zoom, rotate) that are to be applied to the currently selected slide (or to multiple slides). Additionally, in one preferred embodiment the user will be able to identify a subset of the image upon which to apply the selected movement effects. This region will preferably be signalled to the computer by using the mouse pointer to adjust, for example, a default rectangle that has been drawn on top of a graphic image of the selected slide. Preferably, the user will be able to adjust the dimensions of the selection rectangle to suit his or her own preferences. Of course, in some instances the user might elect not to choose a subset of the image and, in which case, the selected effect will be applied to the entire image.

As a next preferred step the user will be presented with an opportunity to select parameters associated with the selected effect. For example, if the user has elected to rotate the slide, he or she will be given an opportunity to specify the angle of rotation (e.g., 45°, 90°, etc.) and direction (clockwise or counter clockwise) that it is to be applied. Further, at this stage the user will preferably be given an opportunity to select the portion of the selected digital image that is to utilized in the video work to allow for the case where a user to, say, zoom into an image and then use only the part of the image that is visible after the zoom has been applied in the video work.

As a next preferred step the user might choose to modify the default timings associated with one or more of the digital images. That is, the instant invention will preferably have a default time setting which specifies the length of time each digital image will be visible in the final video work. A user will preferably be able to accept or modify the default timing for a single slide, a few slides, or every slide according to his or her desire. In some preferred embodiments the user will be restricted to selecting from among a fixed list of possible slide timings but in other embodiments the user will be allowed to specify a precise time duration (e.g., 15.27 seconds). Where movement effects are utilized, the user will preferably be able to specify a starting and ending time for such to allow for the possibility that an image could be, for example, viewed for a few seconds as a static image and then zoomed.

After each selection/definition of an effect or after modification of an effect parameter the instant invention will preferably immediately display the image after application of the selected effect(s) in a preview window so that the user can immediately evaluate the consequences of his or her effect choice. If the user is satisfied with the appearance of the image after the effects have been applied, the instant invention preferably automatically switches to the next digital image in the sequence. Alternatively, the user can manually cycle through the available digital still images using on-screen buttons in the graphical user interface that will preferably have been provided for that purpose. The selected effects and parameter settings are preferably saved in a file separate from the digital image and the original image will be left unmodified.

In the event that the user wishes to define rotation effects for the currently selected image, on-screen graphical indicia (e.g., buttons, arrows, etc.) will preferably be provided to enable the user to quickly specify the rotation parameters. The user might be offered a collection of preset rotation effects to choose from (e.g., with pre-selected rotation starting/ending angles, rotation speeds, directions, etc.) or allowed to specify each parameter separately

It should be clear that an approach such as the foregoing would be a tremendous help for the average user who is trying to create a digital video work from a plurality of digital still images. Preferably, the user will be presented with a graphical user interface that is specifically designed to offer readily at hand the most important features that are necessary when creating a digital video work out of a collection of digital still images. The instant invention is designed to help a user create a video work from a collection of still photos in a matter a minutes, a video work that might take hours to create using conventional software and methods.

Preferably, the process of creating a digital video work will be largely automatic and the user interface will be designed so that an effect can be selected and/or an effect parameter assigned with only a few (or preferably only one) mouse click. Additionally, it is preferred that each change in an effect or change in an effect parameter will be accompanied by at least a preview of the digital image as it will appear after application of the effect.

The foregoing has outlined in broad terms the more important features of the invention disclosed herein so that the detailed description that follows may be more clearly understood, and so that the contribution of the instant inventors to the art may be better appreciated. The instant invention is not limited in its application to the details of the construction and to the arrangements of the components set forth in the following description or illustrated in the drawings. Rather the invention is capable of other embodiments and of being practiced and carried out in various other ways not specifically enumerated herein. Additionally, the disclosure that follows is intended to apply to all alternatives, modifications and equivalents as may be included within the spirit and the scope of the invention as defined by the appended claims. Further, it should be understood that the phraseology and terminology employed herein are for the purpose of description and should not be regarded as limiting, unless the specification specifically so limits the invention. Further objects, features and advantages of the present invention will be apparent upon examining the accompanying drawings and upon reading the following description of the preferred embodiments.

### BRIEF DESCRIPTION OF THE DRAWINGS

Other objects and advantages of the invention will become apparent upon reading the following detailed description and upon reference to the drawings in which:

FIG. 1 illustrates a preferred environment for the instant invention.

FIG. 2A depicts a preferred embodiment of the graphical user interface of the instant invention.

FIG. 2B depicts an expanded view of a portion of the preferred graphical interface of FIG. 2A that contains functions for use in selecting and applying movement effects.

FIG. 3A illustrates a preferred graphical user interface during the editing process.

FIG. 3B depicts an expanded view of a portion of the preferred graphical user interface of the instant invention during the editing process.

FIG. 4 depicts an expanded view of the preferred graphical user interface of the instant invention during the editing process.

FIG. 5 illustrates an expanded view of the preferred graphic user interface as used in connection with the image rotation effect.

FIG. 6 contains a flowchart that illustrates the preferred steps that might be executed when a user applies a movement-type effect.

### DESCRIPTION OF THE PREFERRED EMBODIMENTS

Referring now to the drawings, wherein like reference numerals indicate the same parts throughout the several views, there is provided a preferred system and method for the creation of a video work out of a collection of digital still images, wherein the functionality of the computer program that implements the instant method and its graphic user interface has been designed to make the process as quick and efficient as possible.

Generally speaking the user will be provided with a process that is targeted to accelerate the creation process of a digital video work, thereby enabling the user to access all features and functions associated with the creation process within one displayed graphical user interface.

For purposes of the instant embodiment it should be understood that the invention preferably seeks to eliminate many of the problems and annoyances that might be experienced by a user who is attempting to create a video work out of a plurality of available digital still images. This goal is accomplished herein by providing the user with a program that implements the essential functions that are necessary to creating such a video work in an easy to user graphical user interface.

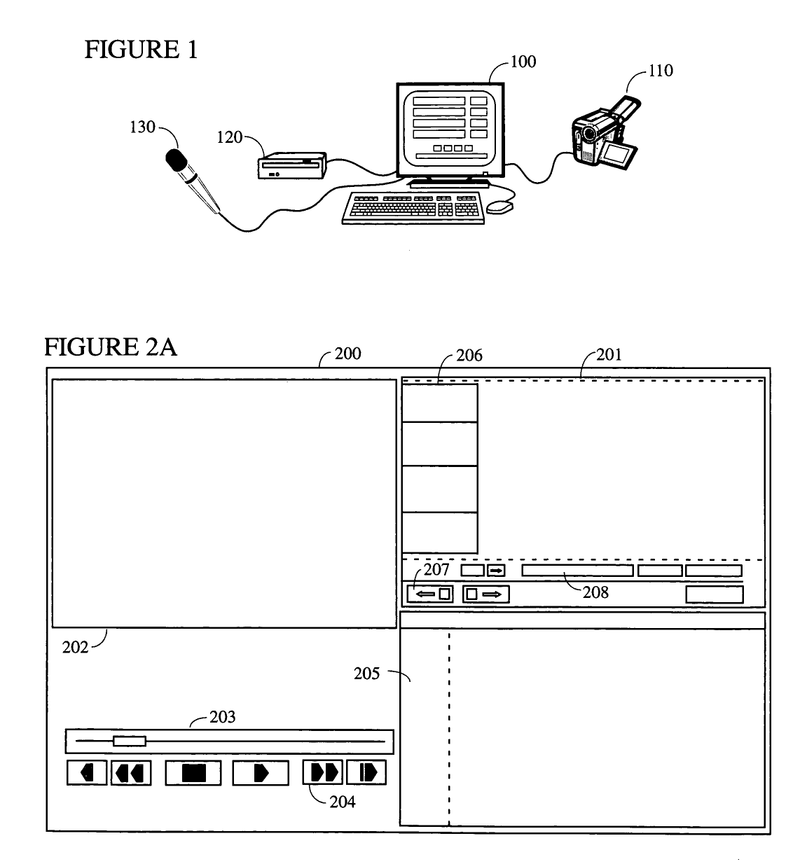

Turning now to a discussion of the general environment of the invention, as is generally indicated in FIG. 1 at least a portion of the instant invention will be implemented in form of software running on a user's computer 100 such computer comprising at least a CPU and a display device. Such a computer will have access to amount of program memory and hard disk storage (whether internal or accessible via a network) as is conventionally utilized by such units.

Additionally it is possible that an external camera 110 of some sort could be utilized with—and will be preferably connectible to—the computer so that video and/or graphic information can be transferred to and from the computer (FIG. 1). Preferably the camera 110 will be a digital video or photo camera, although that is not a requirement. Further given the modern trend toward incorporation of cameras into other electronic components (e.g. in handheld computers, telephones, laptops, etc.) those of ordinary skill in the art will recognize that the camera might be integrated into the computer or some other electronic device and, thus, might not be a traditional single-purposes video or still camera. Although the camera will preferably be digital in nature, any sort of camera might be used, provided that the proper interfacing between it and the computer is utilized. Additionally a microphone 130 might be utilized so that the user can add voice-over narration to the multimedia work and a CD or DVD burner 120 could be useful for storing in-progress or completed works.

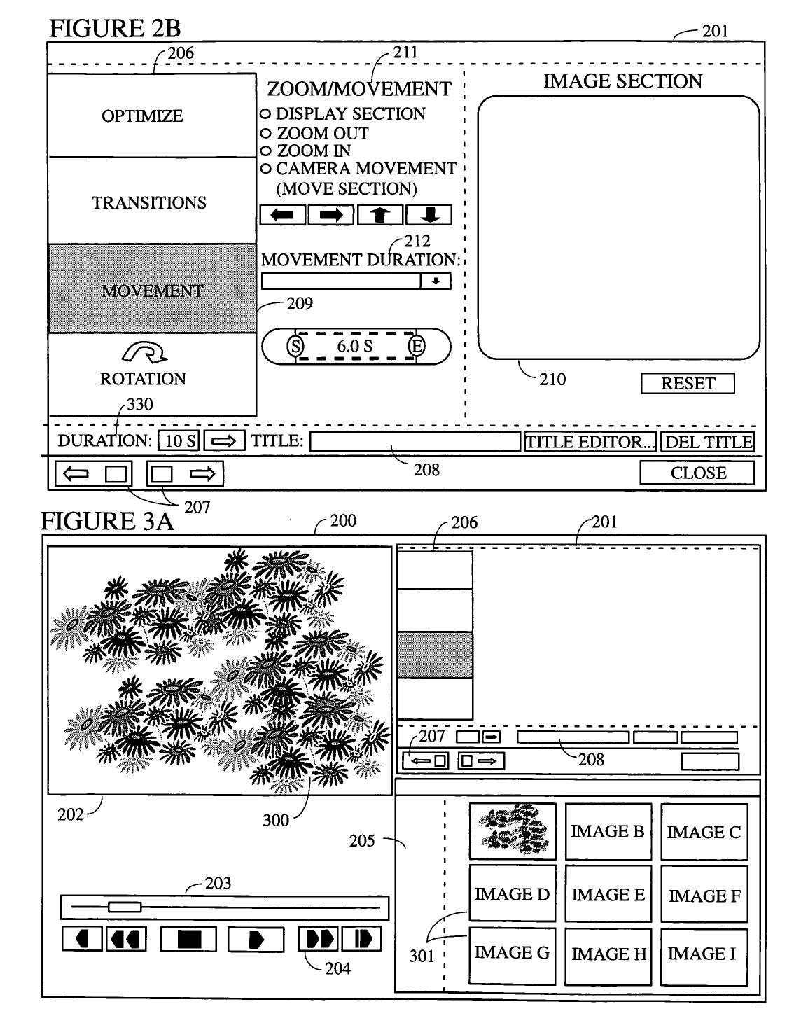

In accordance with FIG. 2, in a preferred embodiment a user of the instant multimedia system software will be presented with a computer screen display 200 within which will be drawn a graphical user interface 201 suitable for use with the instant invention. Among the functionality that such an interface 201 might offer is a preview screen 202 which allows a user to examine the consequences of applying user-selected effects to a video image, preferably in real time. Additionally there will preferably be a region of the screen 205 that is used for data input, e.g., a text listing of digital image file names might be presented here, a display of image thumbnails might be drawn, etc. The user would typically choose from among the input items in this region 205 of the screen as he or she builds the video work.

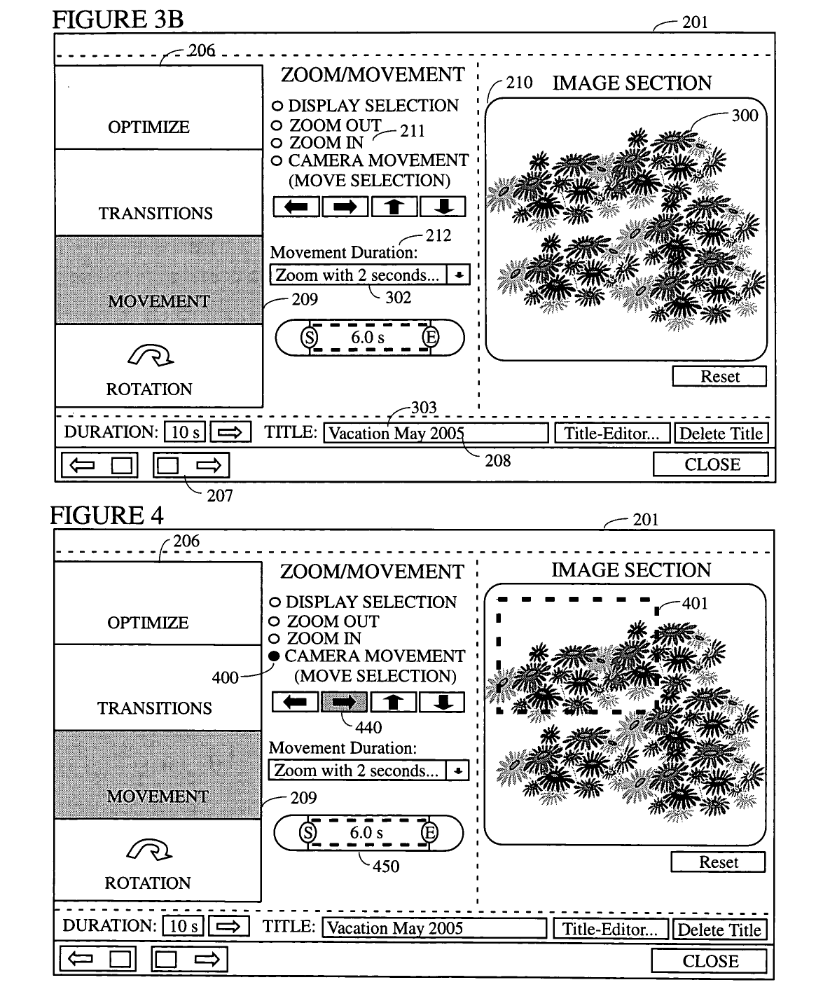

The display section 201 of the graphic user interface (“GUI”) preferably contains a great deal of the functionality of the instant method. In this portion of the screen display 201 (which is shown in greater detail in FIGS. 2B and 3B), many of the functions and features that would be useful in the creation of a video work are arranged for the benefit of the user. For example, FIG. 2B indicates how section 201 might appear if the user has elected to apply a “movement” effect to one of the input images by, for example, selecting one of the options within on-screen menu 206. A small section 210 of the GUI will preferably be devoted to display of the currently selected still image. In the preferred arrangement, some degree of interactivity will be provided so that the user can, for example, use the mouse/pointer to select regions of the image displayed within the image section 210. This sort of selection would be useful where, for example, a user was defining regions of a graphic image to which an effect is to be applied.

Additionally and preferably section 206 of the GUI provides selection buttons 206 that enable the user to quickly switch between functions when creating a digital video work. Preferably, there will be a corresponding change in the menu choices corresponding to the function selection. As is indicated in FIG. 3B, selection of the movement option 209 causes the GUI section 201 to preferably be modified to reflect that choice. For example, various checkboxes 211 related to “Zoom/Movement” are preferably presented in response to selection of option 209. Additionally, a “Movement Duration” parameter 212 and associated drop-down menu 302 (e.g., “zoom for 2 seconds” has been selected) are added to the interface. It is anticipated that in some cases the user might want to utilize a zoom/movement effect that pans the camera across the zoomed image and parameters related to that option have been provided in the “Zoom” menu section 211 including the movement direction, duration, etc.

More generally, a slide duration parameter 330 is preferably made available to control the length of time that the currently selected slide/digital photo will be displayed in the video work. A title that describes the currently selected image can preferably be added via parameter field 208, such image preferably being printed atop the image during part or all of the time that it is visible in the video. Finally, navigation buttons/direction arrows 207 are preferably provided to allow a user to move to the next (or previous) digital image in the series.

On-screen transport controls 204 (FIG. 2A) are preferably provided for control of the developing video work and will be styled to resemble their counterparts on a conventional VCR. These controls provide a mechanism for the user to rewind, play, stop/record, fast forward etc., the video work during the editing process. Those of ordinary skill in the art will recognize that such transport controls 204 are commonplace and well known in media editing programs. It is also typical in such programs to devote some portion of the screen to a timeline display 203 wherein a pointer indicates the general location within the entire video work of the currently selected digital image.

Turning to FIG. 3A, this figure illustrates how the GUI of FIG. 2 might appear during the editing process after a digital still image 300 has been selected. In the file management/ordering section 205 are a collection of images 301 that are available for selection. It is preferred that these image thumbnails 301 be presented in the order that—they will appear in the video work. Of course, it is anticipated that the user will be given an opportunity to reorder them via drag and drop or some other mechanism. In this example, the instant invention has displayed the first available digital still image 300 and given the user an opportunity to adjust the movement effects (which is made clearer in FIG. 3B). Note that in this figure the movement duration has been set (parameter 302) and a title has been entered 303.

FIG. 4 illustrates the screen of FIG. 2 in another preferred arrangement. In this example, the user has selected subset of the digital image 401 a specific image section that is to be used when applying the selected movement effect. This region of the image is indicated visually by a dotted selection rectangle 401 that the user previously selected via the mouse or that has been provided by default. The area enclosed by the rectangle 401 is the section to which the selected effect will be subsequently applied when the video work is created. Additionally note that the user has selected a movement effect, with the direction of camera movement 400 being from left to right. In the preferred arrangement, the selected effect will be immediately applied and displayed in the preview screen 202 for evaluation by the user.

Considering FIG. 4 in greater detail, in the preferred arrangement a user will be able to specify a movement effect with a single click of the mouse once the movement option 209 has been selected. As is indicated in this figure, when a user selects the movement 209 option he or she will preferably be presented with menu items 211 and a selection rectangle 401 will be drawn on top of the slide that is currently being reviewed/edited. Then, depending on which of the movement options 211 are selected, the selection rectangle 401 will operate as follows. First, in the instance that the user selects “Display Selection”, the portion of the slide within the selection rectangle 401 will occupy the entire screen in the resulting movie (and its duration will be six seconds—parameter field 450). If the user selects the “Zoom Out” option, in the resulting movie the contents of the selection box 401 will initially fill the entire screen and then the (virtual) camera will pan away from the image 300 (i.e., increasingly more of the image will be viewable) for the selected period of time or until the entire image 300 is displayed. Similarly, if the “Zoom In” option is chosen, the contents of the selection box will serve as a starting point in the final movie and its contents will be gradually magnified until a maximum zoom level is reached or the designed time 450 expires.

Finally, in the event that the user selects the “Camera Movement” option, he or she can quickly define a specific direction of the movement of a virtual camera by selecting one of the four direction arrows that are located directly below that option. If a user selects, for example, the right arrow 440, the instant program will create a movement effect that makes it appear as though the camera is panning horizontally to the right during the time specified by the user. During the rendering/playback of the resulting movie the panning will continue during the time indicated, with the speed of the pan being such that the window reaches the edge of the image in exactly the time allotted. In some preferred embodiments the pan will move linearly and in others it will move non-linearly (i.e., the movement schedule will potentially be selectable by the user). Similarly, if the up-arrow, down-arrow, or left-arrow is selected the resulting movie will contain that effect. Preferably, and has been described previously, the speed of the horizontal/vertical pan will be such that the image reaches the edge of the image in exactly the time allocated. Additionally, it is preferred that the direction arrows be mutually exclusive (i.e., only one can be selected for a given slide), thereby making it easy for inexperienced users to produce a predictable panning-type effect with a minimum effort. Note that, once the movement option 209 is selected, only a single mouse click is required to specify a horizontally (or vertically) moving effect that utilizes the default time duration 212 and selection rectangle 401.

Note that in some preferred embodiments the user will be allowed to resize and/or reposition the selection rectangle 401 before/after selecting a particular movement effect. In other preferred embodiments, the user will be provided with a default selection rectangle 401 (which might be specified by the software designer or which may be a copy of a previously used customized selection region created by the user). In other preferred arrangements, the aspect ration of the selection rectangle 401 will be required to match the anticipated output movie format (e.g., 4:3, 16:9, etc.).

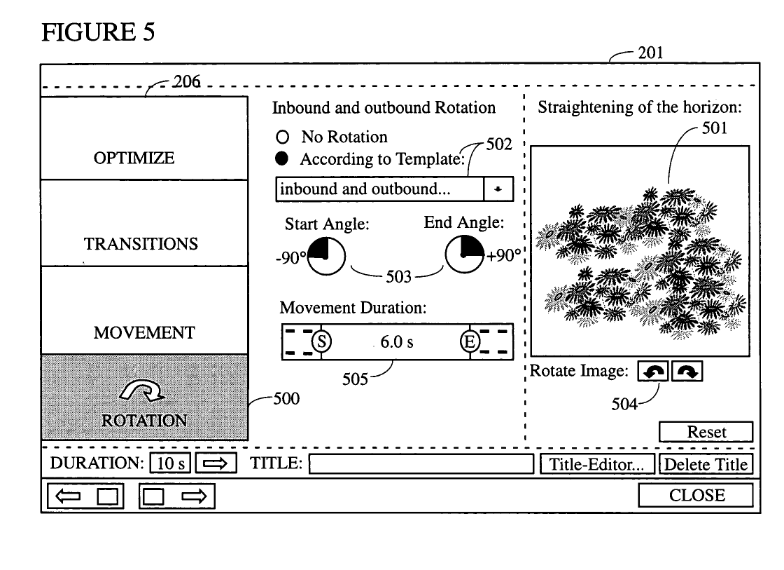

FIG. 5 displays a preferred graphical user interface variant of the instant invention that would appear after the user selected the “rotation” tab 500. Preferably, and as is illustrated in this figure, the user will be presented with various parameter choices associated with the rotation effects including, without limitation, various rotation templates 502, starting and ending rotation angles 503, rotation directions 504, etc. The movement duration parameter 505 allows a user to have the image rotate for all (or only part) of the time that it is visible. As has been discussed previously, preferably a preview screen 501 will be provided so that the user can see the selected effect in real-time, albeit potentially at a lower resolution than the resolution of the output video work.

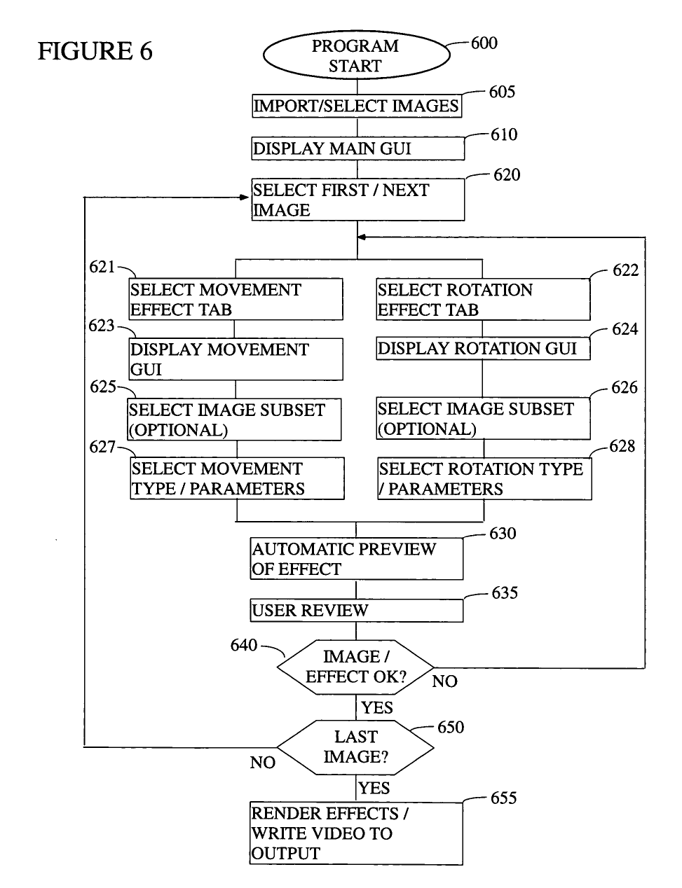

Turning next to FIG. 6, in this figure is contained an overview of a preferred operating logic of the instant invention as applied to the selection of moving video effects. As a first preferred step 600, a program that implements the methods taught herein will be started and initialized according to methods well known to those of ordinary skill in the art. Next the user will preferably select some number of digital still images for import (step 605) after which the main editing GUI will be displayed (step 610) on the user's display device. Note that in the preferred arrangement during the input phase the user will indicate a directory containing images (and potentially subdirectories) that are to be read into the instant program. The program will preferably read the file names (and, preferably, thumbnails) of each of the designated images into memory. At that time an initial ordering of the images will take place, with the default ordering being based on file name (e.g., alphabetical or reverse alphabetical), creation date (e.g., earlier images are placed ahead of later ones), file size, modification date, etc. In brief, preferably the user will determine which ordering the program is to use in its initial arrangement. Further, the user will be given the opportunity (as was described previously) to manually reorder the digital images to suit his or her taste.

Next, the first (or next) image will be selected for editing (step 620) according to the ordering established previously. Preferably this selection will be made automatically.

As a next preferred step, the user will be allowed to select from any of the on-screen menu items 206. However, for purposes of illustration the logic associated with the “Movement” and “Rotation” tabs only will be discussed below.

If the user selects the movement tab (step 621), as a next preferred step the instant program 600 will draw the “Movement” GUI (step 623) and give user the option of selecting a subset of the current image for purposes of applying a digital effect (step 625). If the user does not so limit the area of the effect, preferably it will be applied to the entire image.

As a next preferred step, and for purposes of illustration only, the user will select the movement effect 627 type and associated parameters that is to be applied onto the current image. As has been discussed previously, when this option is selected preferably the GUI will be modified accordingly (step 623). The sorts of parameters that might be specified in connection with this effect have also been previously discussed.

If, on the other hand, the user selects the “Rotation” tab (step 622) a similar sequence of events will take place. Preferably, the next step will involve display of a specialized rotation GUI (step 624), which will preferably provide the user with an opportunity to select a subset of the image for application of the rotation effect (step 626). The user will also be given an opportunity to modify the default rotation parameters (if such have been provided) in step 628.

Preferably, each selection of a different effect (or effect parameter) will result in an automatic preview 630 of the effect in conjunction to the defined image area. This might either be a one-time application of the effect or a loop, wherein the effect is repeated several times to help the user evaluate it (step 635). If the user is satisfied with the view of the image after application of the selected effect/parameters, the instant invention next automatically selects the next slide in sequence (steps 650 and 620). This process is preferably repeated until all of the input slides have been processed. After the last image has been edited (the “YES” branch of step 650), the instant invention preferably will write the collection of slides and associated effects/transitions/etc. to output. Note that in most cases the effects specified by the user will not actually be calculated until this step and that the previews that are presented during the editing process may be lower-resolution approximations to the effects that are calculated at this step.

If the user is not satisfied with the appearance of the image/effect(s) combination, the instant program will preferably allow him or her to modify the existing effect, or add another (the “NO” branch of decision step 640).

Finally, another preferred editing function that will be provided to the user will be accessed via the “Optimize” button illustrated in, for example, FIG. 2B. Preferably, the “Optimize” feature will enable a novice user to quickly and automatically color balance, contrast enhance, and adjust the brightness of a digital image. Algorithms for automatically performing these sorts of operations are well known to those of ordinary skill in the art. In the preferred embodiment, when a user clicks on this button the currently selected image will be automatically adjusted according to such algorithms, thereby improving the quality of image as it will subsequently appear in the resulting video work.

### CONCLUSIONS

Of course, many modifications and extensions could be made to the instant invention by those of ordinary skill in the art. For example, although the instant disclosure has taught the application of movement/zoom effects to digital images, those of ordinary skill in the art will understand that there are many other sorts of effects that might be added including, without limitation, color balancing, digital filtering (noise removal/addition, edge enhancement, etc.), etc., and such could certainly be integrated into the GUI.

Finally, it should be noted that a key aspect of the instant invention is that is allows the creation of a video work from a collection of still images in a very efficient manner. This is accomplished by intelligent selection of default values, by use of a specially designed user interface that has been customized for each function or effect that is to be applied, etc. Further, all of the parameters associated with each effect are preferably presented together on the user's screen in the same single display so that the user does not need to navigate through a maze of menus in order to perform even complex editing of the input digital images.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those skilled in the art, without departing from the spirit of the inventive concept the scope of which is to be determined by the following claims.

1. (canceled)

2. (canceled)

3. (canceled)

4. (canceled)

5. (canceled)

6. (canceled)

7. (canceled)

8. (canceled)

9. (canceled)

10. A method of creating a video work from a plurality of digital still images, wherein is provided a plurality of movement effects, comprising the steps of:
(a) automatically selecting said plurality of digital still images;
(b) ordering said plurality of digital images;
(c) selecting one of said ordered digital images;
(d) automatically choosing a pre-defined selection region within said selected digital image;
(e) specifying a time duration;
(f) selecting a movement effect from among said plurality of movement effects;
(g) applying said selected movement effect to said selection region of said selected image for said time duration, thereby creating a rendered video clip;
(h) performing steps (c) through (g) at least twice, thereby producing at least two rendered video clips;
(i) combining said rendered video clips, thereby creating said video work; and,
j) writing said video work to computer readable media

11. A method of creating a video work from a plurality of digital still images according to claim 10, wherein step (j) comprises the step of combining together any rendered video clips from step (g) according to said ordering of step (b), thereby creating a video work.

12. A method of creating a video work from a plurality of digital still images according to claim 10, wherein said plurality of movement effects comprises a left-horizontal pan, a right-horizontal pan, an upward-pan, and a downward-pan.

13. A method of creating a video work from a plurality of digital still images according to claim 12, wherein said step (f) comprises the step of selecting a movement effect from among said left-horizontal pan, said right-horizontal pan, said upward-pan, and said downward-pan.

14. A method of creating a video work from a plurality of digital still images according to claim 13, wherein said step (g) comprises the steps of:
(g1) determining an initial position of a selection region,
(g2) determining a movement direction based on said selected movement effect,
(g3) determining a movement schedule based on said movement direction, said initial position, and said time duration, wherein said movement schedule terminates at an edge of said image,
(g4) calculating a rendered video clip based on said selection region and said movement schedule.

15. A method of creating a video work from a plurality of digital still images according to claim 10, wherein said selection region is a rectangle.

16. A method of creating a video work from a plurality of digital still images according to claim 10, wherein said plurality of movement effects comprises a zoom-in effect, and a zoom-out effect, and a stationary display effect.

17. A method of creating a video work from a plurality of digital still images according to claim 16, wherein said step (f) comprises the step of selecting a movement effect from among said zoom-in effect and said zoom-out effect.

18. A method of creating a video work from a plurality of digital still images according to claim 10, wherein said plurality of movement effects comprise a rotate clockwise effect and a rotate counter clockwise effect.

19. A method according to claim 10, wherein all of said at least two rendered video clips are of a same time duration.

20. A method of creating a video work from a plurality of digital still images, wherein is provided a plurality of movement effects, comprising the steps of:
(a) automatically ordering said plurality of digital still images;
(b) selecting one of said ordered digital images;
(c) automatically choosing a pre-defined selection region within said selected digital image;
(e) automatically specifying a time duration;
(f) selecting a movement effect from among said plurality of movement effects, wherein said selection of a movement effect is accomplished via a single mouse click,
(g) applying said selected movement effect to said selection region of said selected image for said time duration, thereby causing a rendered video clip to be created with a single mouse click;
(h) performing steps (c) through (g) at least twice;
(i) combining together any rendered video clips from step (g), thereby creating said video work; and,
(j) writing said video work to computer readable media.

21. A method of creating a video work from a plurality of digital still images, comprising the steps of:
(a) opening a window on a computer display device;
(b) displaying at least a portion of said selected digital image within said window;
(c) displaying within said window a plurality of effect indicia representative of a corresponding plurality of movement effects;
(d) displaying within said window aplurality of movement indicia representative of a movement direction, each of said movement indicia representing a different movement direction;
(e) selecting one of said plurality of digital still images;
(f) defining a selection region within said selected image;
(g) receiving from a user a selection of one of said plurality of movement indicia, said selected movement indicia corresponding to a selected movement direction;
(h) receiving from a user a selection of one of said plurality of effect indicia, said selected effect indicia corresponding to a selected movement effect;
(i) applying said selected movement effect in said selected direction to said selection region within said selected image, thereby creating a rendered video item;
(j) performing at least steps (e) through (i) at least twice, thereby creating at least two rendered video items;
(k) combining together said rendered video items, thereby creating said video work; and,
(l) performing at least a portion of said video work on said computer display device.

22. A method of creating a video work from a plurality of digital still images according to claim 21, wherein said plurality of movement effects comprises at least two of a pan movement effect, a zoom movement effect, and a rotation movement effect.

23. A method of creating a video work from a plurality of digital still images according to claim 21, wherein said step (j) comprises the steps of:
(i1) determining an initial position of said selection region,
(i2) determining a movement schedule based at least on said movement direction, and said initial position, wherein said movement schedule terminates at an edge of said image, and,
(i3) calculating a rendered video item based at least on said selection region, said movement schedule, and said selected movement effect.

24. A method of creating a video work from a plurality of digital still images according to claim 21, wherein said selection region is a rectangle.

25. A method according to claim 21, wherein all of said at least two rendered video items are of a same time duration.

26. A method of creating a video work from a plurality of digital still images according to claim 21, wherein step (e) comprises the step of automatically selecting one of said plurality of digital still images.

27. A method of creating a video work from a plurality of digital still images according to claim 21 further comprising the step of
(m) writing said video work to computer readable media.

28. A method of creating a video work from a plurality of digital still images according to claim 21, wherein said plurality of movement effects comprises at least two of a horizontal pan, a vertical pan, a zoom-in, a zoom-out, a clockwise rotation, and a counter clockwise rotation.

29. A method of creating a video work from a plurality of digital still images, wherein is provided a plurality of movement effects, each of said movement effects having at least one parameter associated therewith, comprising the steps of:
(a) opening a window on a computer display device;
(b) displaying within said window a plurality of indicia representative of at least a portion of said plurality of movement effects, each of said displayed indicia representing a different one of said movement effects;
(c) defining a parameter region within said window;
(d) selecting one of said plurality of digital still images;
(e) displaying at least a portion of said selected digital image within said window;
(f) defining a selection region within said selected image;
(g) receiving from a user a selection of one of said movement effect indicia, said selected effect indicia being associated with a selected movement effect and said selected movement effect having at least one parameter value associated therewith;
(h) displaying within said parameter region indicia representative of a value of least one of said at least one parameters associated with said selected movement effect;
(i) allowing a user to modify zero or more values of said at least one displayed parameter values associated with said selected movement effect via interaction with said displayed indicia representative of said parameter values, thereby creating a user sanctioned parameter set;
(j) applying said selected movement effect according to said user sanctioned parameter set to said selection region of said selected image, thereby creating a rendered video item;
(k) performing at least steps (e) through (i) at least twice, thereby creating at least two rendered video items;
(l) combining together said rendered video items, thereby creating said video work; and,
(m) writing said video work to computer readable media.

30. A method of creating a video work from a plurality of digital still images according to claim 29, wherein said plurality of movement effects comprises at least two of a pan movement effect, a zoom movement effect, and a rotation movement effect.

31. A method of creating a video work from a plurality of digital still images according to claim 30, wherein said pan movement effect has associated parameters chosen from a list consisting of a pan direction, a pan speed, and a pan time duration.

32. A method of creating a video work from a plurality of digital still images according to claim 29, wherein said plurality of movement effects comprises at least two of a horizontal pan, a vertical pan, a zoom-in, a zoom-out, a clockwise rotation, and a counter clockwise rotation.

33. A method of creating a video work from a plurality of digital still images, wherein is provided a plurality of movement effects, comprising the steps of:
(a) opening a window on a computer display device;
(b) displaying at least a portion of said selected digital image within said window;
(c) displaying within said window a plurality of indicia representative of each of said plurality of movement effects, each of said indicia representing a different one of said movement effects;
(d) selecting one of said plurality of digital still images;
(e) receiving from a user a selection of one of said effect indicia, said selected effect indicia corresponding to a selected movement effect;
(i) immediately upon receiving said user selection, applying said selected movement effect to said selection region of said selected image, thereby creating a rendered video item;
(g) performing at least steps (d) through (f) at least twice, thereby creating at least two rendered video items;
(h) combining together said rendered video items, thereby creating a video work; and,
(i) writing said video work to computer readable media.

34. A method of creating a video work from a plurality of digital still images according to claim 33, wherein said plurality of movement effects comprises at least two of a pan movement effect, a zoom movement effect, and a rotation movement effect.

35. A method of creating a video work from a plurality of digital still images according to claim 34, wherein said pan movement effect has associated parameters chosen from a list consisting of a pan direction, a pan speed, and a pan time duration.

36. A method of creating a video work from a plurality of digital still images according to claim 33, wherein said plurality of movement effects comprises at least two of a horizontal pan, a vertical pan, a zoom-in, a zoom-out, a clockwise rotation, and a counter clockwise rotation.
